(19) United States
(12) Patent Application Publication
(10) Pub. No.: US 2014/0114449 A1
(43) Pub. Date: Apr. 24, 2014

(54) Computerized System and Method for Mixing Multiple Sources of Sports Statistics Projections

(71) Applicant: Advanced Sports Logic, Inc., Rochester, NH (US)

(72) Inventors: Leonard John LaPadula, III, Rochester, NH (US); Robert Freemnan, Manchester, CT (US)

(73) Assignee: Advanced Sports Logic, Inc., Rochester, NH (US)

(21) Appl. No.: 13/739,955

(22) Filed: Jan. 11, 2013

Related U.S. Application Data
(60) Provisional application No. 61/586,143, filed on Jan. 13, 2012.

(51) Int. Cl. G06F 17/00

(52) U.S. Cl. CPC G06F 17/60
USPC 700/91

(57) ABSTRACT

The present invention is a system and method for generating composite sets of rest-of-season sports projections from one or multiple sets of current-week projections, and a base set of rest-of-season projections for use in fantasy sports.

This utility non-provisional patent application claims the benefit of the previously filed provisional patent 61/586,142, filed Jan. 13, 2012.

### TECHNICAL FIELD

The present invention relates generally to a system and method for generating sports statistics projections from multiple sources of varying completeness and quality. More specifically, the invention relates to a computerized system and method for using a base set of rest-of-season projections and several sources of current-week only projections to build composite rest-of-season projections.

### BACKGROUND OF THE INVENTION

Sports statistics projections are frequently used for fantasy sports, such as fantasy football. Many mainstream and specialized sports and fantasy sports media companies make up-to-date statistics projections and commentary available for a whole season before the season begins, and for each team's next game as the season progresses. However, there are relatively very few sources that provide up-to-date projections for all future games of a season at one time. This is because it takes considerable technology and expense to generate the amount of data it requires to project and represent the statistics of all games of a season. AccuScore is an example of one source of “rest-of-season” projections. They create projections by running advanced simulations of each game ten thousand times and averaging the result.

It is recognized that the prior art fails to provide fantasy sports team managers and league providers with sufficient projection data to optimize team and league management. What is needed is an objective method for easing the creation of rest-of-season projections so that an average sports media company can create rest-of-season projections with current sports expert resources so that fantasy sports team managers and league providers will have more information for decision making and entertainment value.

For example, the fantasy sports industry has limited tools for evaluating player trades between fantasy teams. Typically, when two team managers decide to trade players, other team managers within the league are allowed to protest the trade to protect against collusion. Trade disputes by their very nature are generally contentious. Only recently has the art advanced to the point where trades can be evaluated based on their merit to each team based on rest-of-season projections. However, in arbitrating trades using this technology, various league managers will not agree with the arbitration decision because they disagree with the quality of the underlying projections used in making the decision. By evaluating the trade using multiple sources to create reliable composite projections, trade arbitration becomes a viable solution for reducing contentious trade disputes in fantasy leagues.

Furthermore, most fantasy leagues have a regular portion and a playoff portion to the fantasy season. Recent advances in the art of team management tools make it possible to mathematically optimize selection of players for achieving enough wins to get to the playoffs, versus optimizing scoring during the playoff weeks to maximize the probability to win the playoffs. Specifically, losing a few games during the regular season generally does not reduce a team's probability to win the championship. However, losing any game during the playoffs completely eliminates a team's opportunity to win the championship. For example, a product called The Machine by Advanced Sports Logic uses projection variance and accuracy as part of its system for providing team management recommendations. (Applicant's own work). If projection variance (the amount projections change from week-to-week) and accuracy (how closely a final projection matches real results) are improved, The Machine can relax team fantasy point margins for regular season matchups in order to better optimize for maximum fantasy point margins during playoff matchups.

In summary, by reducing the barrier to produce reliable rest-of-season projections, it becomes more likely that a greater number of sources of high quality rest-of-season projections will become available for aiding team managers to optimize their player selections and for arbitrating trade disputes.

### BRIEF DESCRIPTION OF THE DRAWINGS

The present invention will be described by way of exemplary embodiments, but not limitations, illustrated in the accompanying drawings in which like references denote similar elements and in which:

FIG. 1 is a flow diagram illustrating the method steps for mixing multiple sources of sports statistics projections, in accordance with one embodiment of the present invention.

FIG. 2 is a graphical user interface showing blended and extrapolated rest-of-season projections based on a ratio of current week projections to base projections based on the method shown in FIG. 1, in accordance with one embodiment of the present invention.

FIG. 3 is a graphical user interface enabling a user to edit whole season team passing projections and set anchor points for the rebalancing based on the method shown in FIG. 1, in accordance with one embodiment of the present invention.

FIG. 4 is a graphical user interface enabling a user to edit single game passing projections and set anchor points for the rebalancing based on the method shown in FIG. 1, in accordance with one embodiment of the present invention.

FIG. 5 is a flow diagram illustrating a few possible uses for the method shown in FIG. 1.

FIG. 6 is a graphical user interface representing a trade arbitration solution using multiple sets of rest-of-season projections.

FIG. 7a illustrates how the method and system of the present invention can help to improve a team's probability to win by providing more accurate projections as input.

FIG. 7b illustrates how the method and system of the present invention can help to improve a team's probability to win by providing more accurate projections as input.

FIG. 7c illustrates how the method and system of the present invention can help to improve a team's probability to win by providing more accurate projections as input. By reducing 1-sigma in regular season, more focus can be directed toward playoff games.

### DETAILED DESCRIPTION OF THE INVENTION

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

The disclosed system and method provides a fantasy sports team manager or sports-media company an analytical tool to combine commercially available current-week projections with commercially available rest-of-season projections to create alternative, composite sources of rest-of-season projections.

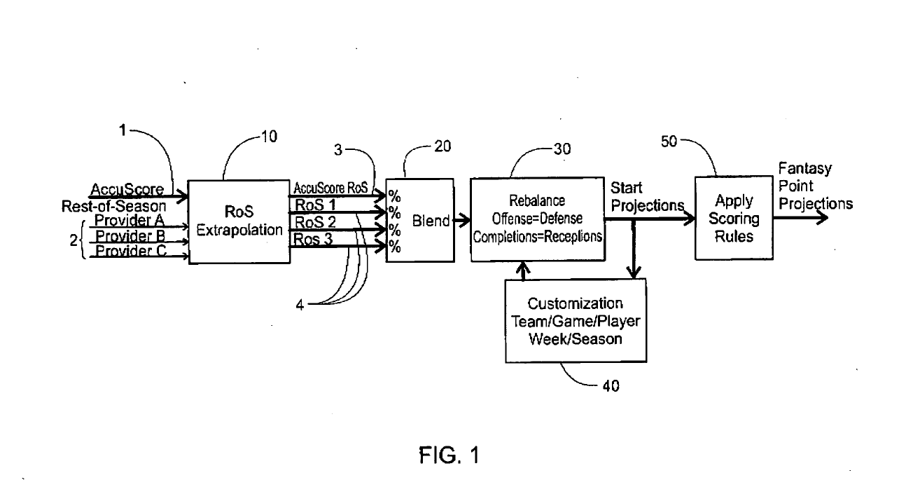

In an exemplary embodiment of the present invention, shown in FIG. 1, AccuScore rest-of-season projections 1 and multiple sources of current-week projections 2 might be available input. Each of the sources of current-week projections might be extrapolated through the rest-of-the season by calculating a ratio of each current-week statistics projection to each of the matching AccuScore's statistics projection of the same week 10. Then using the ratio, calculate new values for all projected statistics for the remainder of the season. For example, if in week 3 Provider A projects that Aaron Rodgers will throw 330 passing yards and AccuScore projections that Aaron Rodgers will throw 300 passing yards, then Provider A's ratio of passing yards for Aaron Rodgers is 1.1 times AccuScore's projection. Now a new set of rest-of-season projections for Aaron Rodgers passing yards can be generated by multiplying each of AccuScore's week 4 through week 17 projections by 1.1.

The extrapolation method might also have some clipping of the max and min ratio to ensure generated projections stay within a reasonable range of AccuScore's projection. For example, the extrapolation method might set the minimum ratio for extrapolation at 0.50 and the maximum ratio of extrapolation at 1.5.

Next, the AccuScore rest-of-season projection 3 and the multiple extrapolated rest-of-season projections 4 might be blended 20 based on some selections by a user. For example, a user trying to generate their own preferred final rest-of-season projections might have a bias toward Provider B and set blend percentages to more heavily weight the use of the rest-of-season projections resulting from Provider B's current-week statistics projections. For example, AccuScore, Rest-of-Season Extrapolation 1 and Rest-of-Season Extrapolation 3 results could each be multiplied by 0.20 while Rest-of-Season Extrapolation 2 could be multiplied by 0.40 and the products summed together, such that the resulting blend of projections weights Provider B's projections twice as heavily as each of the other sets of projections.

Some providers might not provide exactly the same set of statistical projections as the base provider. In fantasy sports, various scoring systems are used for calculating fantasy points. Most providers of current-week projections project only the most critical statistics used for the largest number of scoring systems. When this occurs, it may not be possible to calculate a ratio between the current-week provider's projection and the base provider's projection, unless the extrapolation method fills in using the base provider's projection. For example, AccuScore might project the number of passing 2-point conversions, and Provider C might not project the number of passing 2-point conversions. So, the extrapolated set of rest-of-season projections might use the current-week ratio to calculate most important statistical projections, but it would use the AccuScore base projection for the passing 2-point conversions to fill in a value for the extrapolated set of rest-of-season projections.

Some current-week providers might provide less detail than the base provider regarding a particular statistic. For example, AccuScore might provide field goal information, such as attempted and completed field goals for different ranges, such as from 0 to 29 yards, 30 to 39 yards, 40 to 49 yards, and 50-plus yards. However, the current-week projection provider might only provide completed field goals. In this case, the extrapolated projections can still be detailed by using AccuScore's ratio of attempted versus completed field goals to fill in a reasonable value for the current-week projection provider for the attempted field goals. Also, AccuScore's ratio of field goals that fall in each yardage range can be used to fill in a reasonable value for each range. More specifically, if AccuScore projects that in the current week that Robbie Gould will make five field goal attempts and that he will complete one 0-29 yard field goal, two 30-39 yard field goals, and one 40-49 yard field goal for the current week, and Provider A projects that Robbie Gould will make five field goals, but provides no other information, the method and system of the present invention could fill in the current-week projection by using the ratio of five to four (1.2) completed field goals to create detailed projections from Provider A's input. In this case, the more detailed projection would result in 1.2 missed field goals, 1.2 field goals from 0-29 yards, 2.4 field goals from 30-39 yards and 1.2 field goals from 40-49 yards. These values would then be used as if they are the current-week Provider A's projections for extrapolating data for rest-of-season field goal data.

Next, the set of extrapolated and blended projections might be rebalanced 30 such that all stats for a single game are balanced. For example, let's say that after extrapolation and blending, in week 5, the New England Patriots play the Baltimore Ravens. Now let's say that the resulting blended projections for that game indicate that Tom Brady will pass for 310 yards, the Baltimore Ravens defense will allow 300 passing yards, and all the New England Patriots receivers, running backs, and tight ends will receive a total of 250 passing yards. Rebalancing might first balance Tom Brady's passing yards with the received yards by averaging the results, so Tom Brady would be rebalanced down to 280 passing yards and the receivers would be rebalanced up so that their sum of receiving yards would be rebalanced up to 280 passing yards. Now Tom's passing yards match the total receiving yards. Next, the total offense passing yards and total yards allowed might be rebalanced by averaging so that they match. Now Tom and all his receivers are rebalanced up to 290 total offensive passing yards and the Baltimore Ravens defense is rebalanced down to 290 passing yards allowed.

Next, the extrapolated and rebalanced statistic projections might be viewable and editable for further customization 40. A sports expert could edit projections at the team level or individual player level and rerun the rebalancing method until results match their expectation of player performance.

Finally, scoring rules 50 might be applied to convert the rebalanced projections into fantasy point projections for use in a team management player selection guidance application or for a media company to publish their projections.

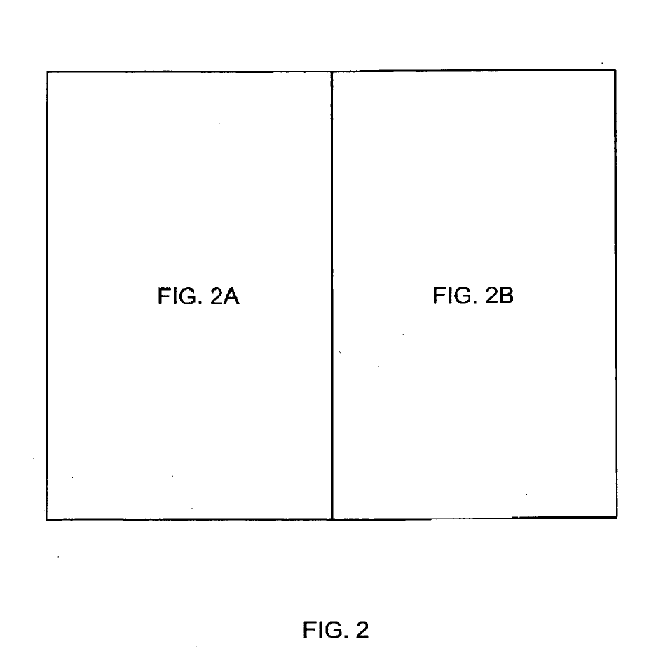

FIG. 2 shows one embodiment of a user interface for viewing blended current-week fantasy point projections 100; the ratio between the blended projection and the AccuScore base projection 110; and the resulting extrapolated projections 120. In one embodiment, a user can change the blending percentages between AccuScore, CBS Jamey Eisenberg, CBS Dave Richard and Fantasy Sharks 130. Fantasy point totals that are the result of blending 100. which could be viewed in one color, while extrapolated values 120 could be viewed in a different color. This is to protect the integrity of representation of third party data. For example, a particular provider might want the user to clearly understand what data is attributable to them versus what is an extrapolated value.

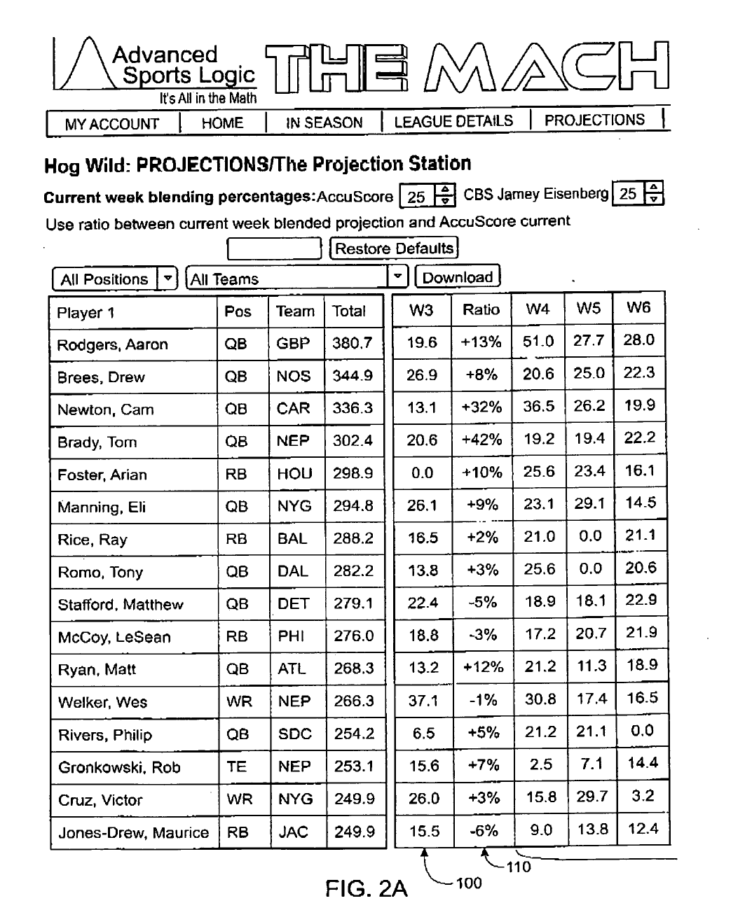

FIG. 3 shows one embodiment of a user interface for a team's whole-season passing statistics. In this view, the user can view the passing performance of a team for each week relative to the whole-season projection. In one embodiment, a user can edit these projections and rerun the rebalancing method so the opposing team's allowed passing yards match, and so the whole-season projection matches the sum of each week's projections. In one embodiment, the user can set anchor points that indicate particular values which will not be changed during rebalancing. For example, a user might want to specify some of the values for a particular game and have the rebalancing step adjust all other projections accordingly.

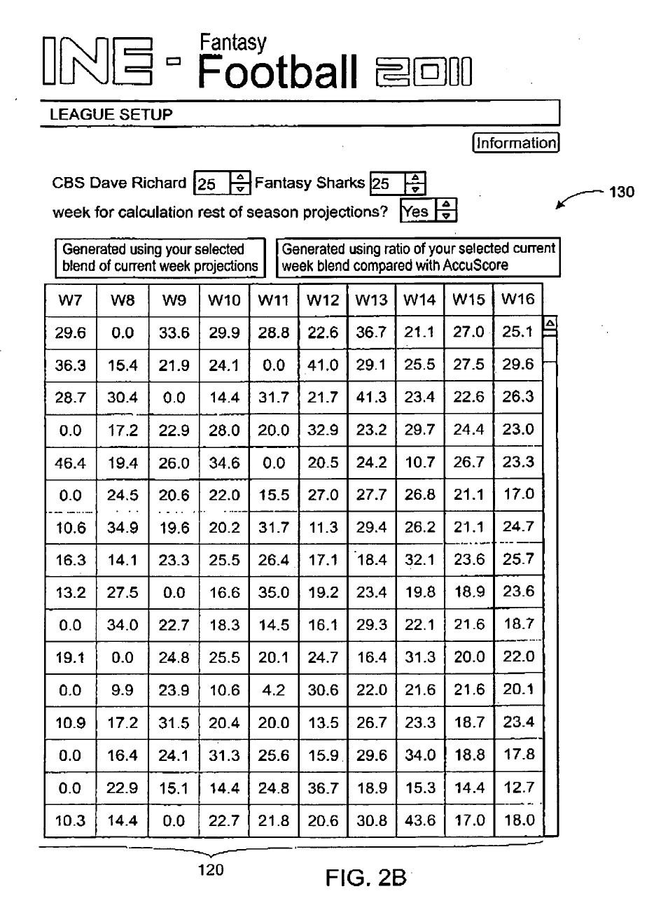

FIG. 4 shows one embodiment of a user interface for a single game's passing statistics. In this view, the user can view detailed passing statistics for each member of a team for a single game. In one embodiment, graphical views might be provided that display how the game's statistics are distributed across members of the team 200. This information might be used to visualize how the statistics might be rebalanced if a particular player became injured. In one embodiment, a user could edit these projections and rerun the rebalancing method so that all the passing statistics projections for a game are balanced. In one embodiment, the user can set anchor points to indicate particular values which will not be changed during rebalancing. Additional user interfaces might be provided for rushing statistics, special team statistics, and defense-oriented statistics. Each user interface will be configured with the ability to edit, set anchor points, and rebalance.

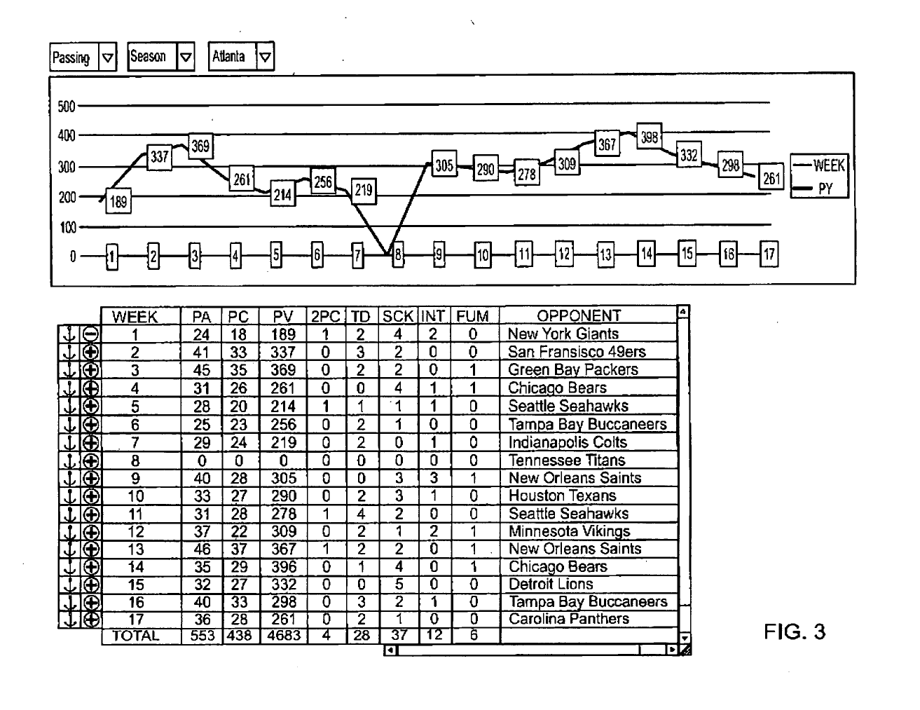

FIG. 5 shows a system and method for enabling media providers to “broadcast” commercially viable rest-of-season projections to fantasy sports enthusiasts. As the state of the art improves, human expertise will fall behind the accuracy of the statistics created through purely automated methods. The system and method of the present invention will enable the controlled use of the most accurate projections by media outlets so they can produce equally high-quality projections. The system and method of the present invention will also be useful to individual fantasy team managers. In one embodiment, the first use of the method and system of the present invention, labeled The Projection Machine, is for use by a media company to create and broadcast rest-of-season projections based on their own sports expertise. In another embodiment, the method and system of the present invention is used by a product, labeled The Machine, that is able to use rest-of-season projections to provide fantasy team player selection guidance. (Applicant's own work).

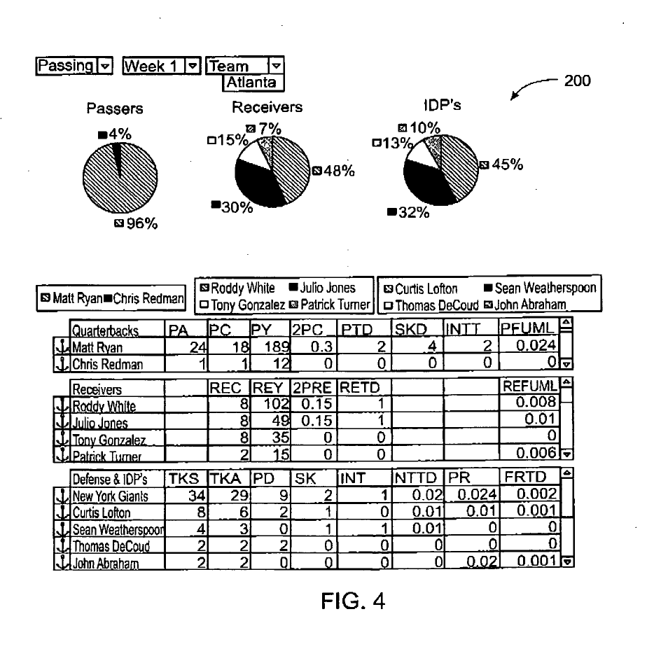

FIG. 6 illustrates how multiple sets of generated rest-of-season projections might be used for trade arbitration. A trade might be analyzed using each of the different sets of rest-of-season projections. If the trade benefited each team with at least one of the four sets of projections, then trade arbitration would indicate that it is a reasonable trade. This is because each fantasy team manager will see that the trade helps their team, and their view is in alignment with at least one major provider of fantasy sports opinions.

If the ability to generate multiple sets of rest-of-season projections is widely distributed, such as through a popular team management player selection guidance product, it would be possible to monitor usage and track accuracy of individual user's customized projections. It would then be possible for the company that makes the team management player selection product to sponsor a contest, populate a leader board and/or propagate the most accurate projections based on up-to-date accuracy measurements to all other users of the team management player selection guidance product.

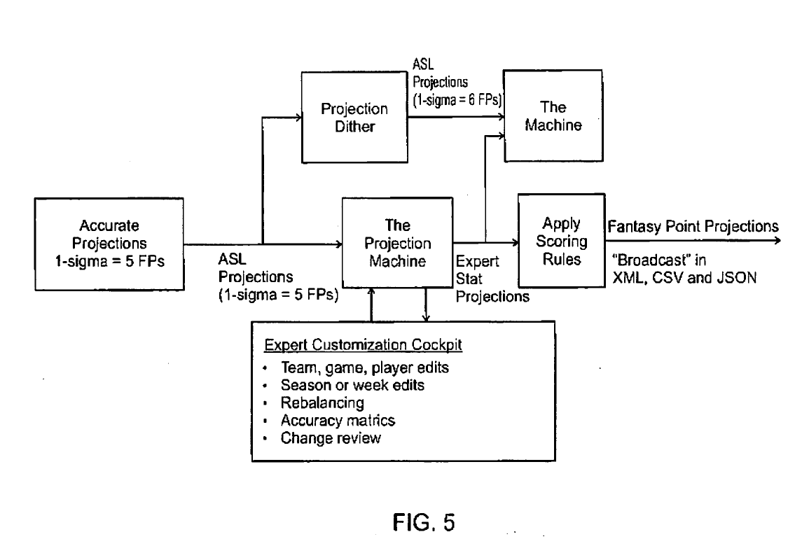

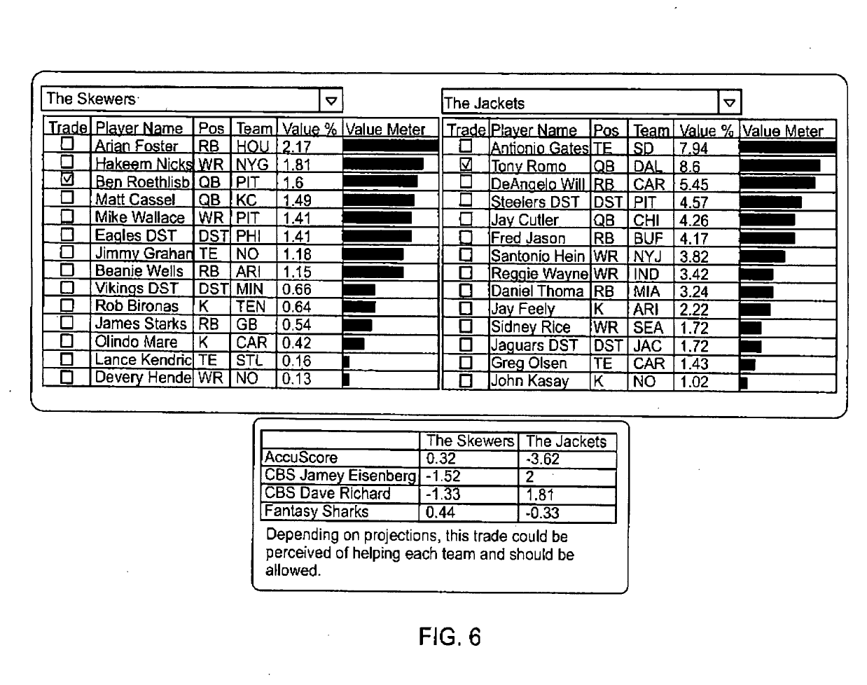

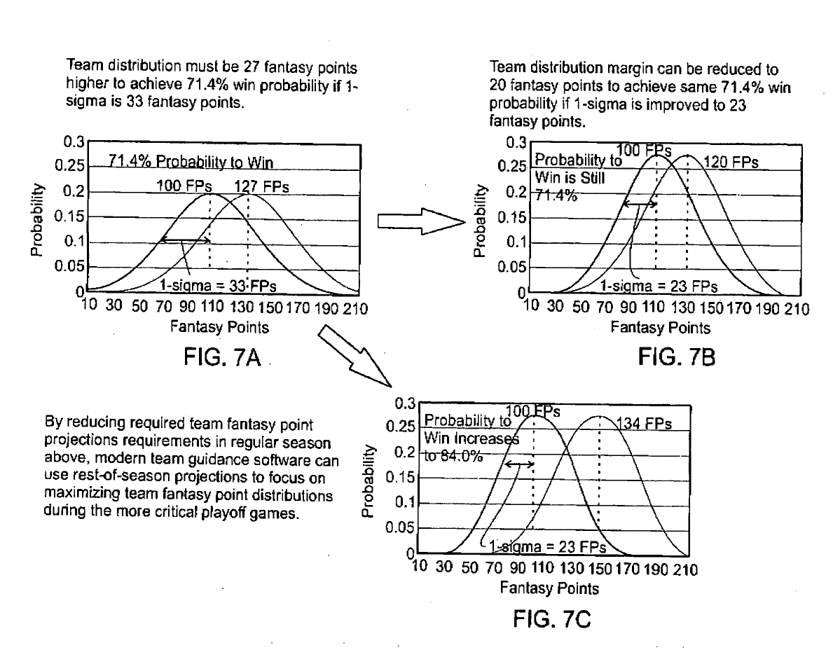

FIGS. 7a-7c illustrate how the method and system of the present invention can help to improve state of the art guidance software to improve a team's probability to win when it has more accurate projections as input. In FIG. 7a, the team distribution must be 27 fantasy points higher to achieve a 71.4% win probability when 1-sigma is 33 fantasy points. In FIG. 7b, the team distribution can be reduced to 20 fantasy points to achieve the same 71.4% win probability if 1-sigma is improved to 23 fantasy points. By reducing the team fantasy point projections requirements in regular season (as shown in FIGS. 7a and 7b), the guidance team software can use rest-of-reason projections to focus on maximizing team fantasy point distributions during the more critical playoff games, as shown in FIG. 7c.

What is claimed is:

1. An automated method for generating blended player projections from multiple sources of current-period-only and rest-of-season projections as an input, where at least one input is rest-of-season projections;

2. The automated method for blending player projections of claim 1, wherein a more complete source of projections is used as a base for filling in data for a less complete source of projections;

3. The automated method for blending player projections of claim 1, wherein a source of rest-of-season projections is used as a base to extrapolate current-period-only projections for rest of the season;

4. The automated method for blending player projections of claim 1, wherein multiple rest-of-season projections are blended variable proportion;

5. The automated method for blending player projections of claim 1, wherein rest-of-season projections are rebalanced to ensure conservation of projected statistics between players within a team and between teams within a game;

6. The automated method for blending player projections of claim 1, wherein a user interface enables sports analyst or fantasy player manually edit projections;

7. An automated method for measuring quality of rest-of-season projections;

8. The automated method for measuring quality of rest-of-season projections of claim 7, wherein quality results are used to guide a fantasy team management tool to make more accurate fantasy point probability distributions;

9. The automated method for measuring quality of rest-of-season projections of claim 7, where in quality measurements are performed across a large set of various customized projections;

10. The automated method for measuring quality of rest-of-season projections of claim 9, wherein quality results are used to facilitate an accuracy contest;

11. The automated method for measuring quality of rest-of-season projections of claim 9, wherein the quality measurement is dynamic as the sports season progresses;

12. The automated method for dynamically measuring quality of rest-of-season projections of claim 11, wherein the quality measurements are used to select which projections to make available for tools to manage a fantasy sports team;

13. A system for generating blended player projections from multiple sources of current-period-only and rest-of-season projections as an input, where at least one input is rest-of-season projections;

14. The system for blending player projections of claim 13, wherein a more complete source of projections is used as a base for filling in data for a less complete source of projections;

15. The system for blending player projections of claim 13, wherein a source of rest-of-season projections is used as a base to extrapolate current-period-only projections for rest of the season;

16. The system for blending player projections of claim 13, wherein multiple rest-of-season projections are blended variable proportion;

17. The system for blending player projections of claim 13, wherein rest-of-season projections are rebalanced to ensure conservation of projected statistics between players within a team and between teams within a game;

18. The system for blending player projections of claim 13, wherein a user interface enables sports analyst or fantasy player manually edit projections;

19. An system for measuring quality of rest-of-season projections;

20. The system for measuring quality of rest-of-season projections of claim 19, wherein quality results are used to guide a fantasy team management tool to make more accurate fantasy point probability distributions;

21. The system for measuring quality of rest-of-season projections of claim 19, where in quality measurements are performed across a large set of various customized projections;

22. The system for measuring quality of rest-of-season projections of claim 21, wherein quality results are used to facilitate an accuracy contest;

23. The system for measuring quality of rest-of-season projections of claim 21, wherein the quality measurement is dynamic as the sports season progresses;

24. The system for dynamically measuring quality of rest-of-season projections of claim 23, wherein the quality measurements are used to select which projections to make available for tools to manage a fantasy sports team.
